(19) United States
(12) Patent Application Publication
(10) Pub. No.: US 2023/0360389 A1
(43) Pub. Date: Nov. 9, 2023

(54) SYSTEMS AND METHODS OF URBAN ROOFTOP AGRICULTURE WITH SMART CITY DATA INTEGRATION

(71) Applicant: DirtSat, Inc., San Francisco, CA (US)

(72) Inventor: Christine TIBALLI, Sausalito, CA (US)

(21) Appl. No.: 18/024,581

(22) PCT Filed: Sep. 16, 2021
(86) PCT No.: PCT/US2021/050608

§ 371 Date: Mar. 3, 2023

Related U.S. Application Data
(60) Provisional application No. 63/080,748, filed on Sep. 20, 2020.

(51) Int. Cl. G06V 20/10; G06V 20/13

(52) U.S. Cl. CPC G06V 20/176; G06V 20/13

(57) ABSTRACT

An IoT-enabled network of urban rooftop farms. Systems and methods include receiving image data; processing the image data with an artificial intelligence model; determining, based on the processing of the image data, a set of pixels of the image data meets one or more thresholds; and based on determining the set of pixels meets the one or more thresholds, recording the set of pixels as a viable agriculture space. Systems and methods also include receiving data from one or more sensors, wherein each of the one or more sensors is associated with an agriculture space; generating one or more metrics indicative of farming viability associated with the agriculture space based on the data received form the one or more sensors; and generating a user interface comprising the generated metrics.

### CROSS-REFERENCE TO RELATED APPLICATIONS

This application claims priority to U.S. Provisional Application No. 63/080,748, filed on Sep. 20, 2020, the entire contents of which are hereby incorporated by reference.

### TECHNICAL FIELD

The present invention relates to urban remote sensing, geographical information systems (GIS), data analytics, Internet of Things (IoT) cloud-connected sensors, and smart city data networks, and more particularly, though not exclusively, to smart cities, food security, and climate mitigation programs using satellite based geospatial data combined with custom GIS, artificial intelligence (AI) analytics, and IoT sensors to index, monitor and connect rooftop urban agriculture networks.

### BACKGROUND

As the world develops and the population of the world increases, the need for agriculture creates a requirement for GIS to be utilized in cities for mapping and infrastructure planning. Contemporary means and uses of GIS involve determining solar viability for rooftops but fail to provide accurate or useful tools for determining whether urban spaces, such as rooftops, may be used for agriculture. For example, current systems lack effective quantitative ranking criteria and protocols for agriculture development of urban rooftops. An automated methodology is needed to develop a comprehensive dataset which is scalable and effective in cities across the globe.

While crop monitoring via sensors may be a viable option in rural areas, urban interfaces cause a host of issues surrounding latency and situational awareness regarding position, velocity, and time (PVT) and loss of sight (LOS). Furthermore, network connectivity can be unreliable in urban areas, due to building materials and geometries, leading to delayed data sync schedules, which interferes with near real-time transfer and analysis of both ground-based and space or air-based information.

Monitoring rooftop agriculture on a city-wide scale requires very high resolution (VHR) imagery due to intercropping, i.e., growing two or more crops within close proximity. Since each plant has its own spectral signature, the intermingling of crops can result in biological interaction, making health determinations difficult to accurately track and measure. Therefore, VHR imagery is highly useful in providing <1 meter spatial resolutions for precise data capture and analytics training and calculations with Normalized Difference Vegetation Index (NDVI) or Solar Induced Fluorescence (SIF) algorithms. VHR, medium resolution, and low resolution datasets may all be utilized to ensure continuity in data capture and assessment for monitoring crop growth, health, and yield forecasting.

Finally, contemporary cloud-based platforms cause concerns related to latency, distribution, and scalability, particularly as the number of IoT devices connected to these networks continues to rise and associated data bottlenecks form.

### SUMMARY

In one exemplary embodiment of the present technology, at least the aforementioned disadvantages can be mitigated or overcome by integrating a networked urban agriculture IoT sensor platform into a smart city data platform, encompassing three central components: (1) identifying and indexing viable infrastructure (through geospatial data, machine learning, and GIS), (2) monitoring and managing rooftop urban agricultural farms (through geospatial data, IoT sensors, and AI analytics), and (3) connecting both crop data and tertiary weather and climate metrics to a smart city data network (through IoT sensors and cloud or cloudlet-enabled data networks).

One exemplary advantage of the systems and methods described herein enables consumers to make more useful and measurable choices regarding urban food security and sustainability projects. Another exemplary advantage of the systems and methods described herein enables cities to extract quantitative environmental data to measure progress or compare against projected outcomes of green infrastructure developments.

According to one or more of the embodiments described herein, a process for remotely monitoring an urban agriculture system may include using very high resolution (VHR) optical, multispectral, and/or synthetic aperture radar (SAR) satellite data and/or other forms of aerial data for remotely sensed imagery. One or more IoT sensors may be used for remotely sensing data from crops, soil beds, weather, or any other related environmental source. One or more microprocessors, or other processing devices, may be used for AI analysis of collected sensor data. A normalized difference vegetation index (NDVI) algorithm may be implemented to monitor crop health. Solar-induced fluorescence (SFI) algorithms may be used to monitor crop stress. Field gateways may facilitate data collection and compression and filtering before the data is moved to the cloud. Cloud or cloudlet data centers may collect, analyze, and distribute data from sensors and/or aerial and/or satellite sources, while decentralizing data storage and compute processes. A data lake or lakehouse may be configured to store captured IoT sensor data. One or more extract, transform, and load (ETL) or extract, load, and transform (ELT) systems may be configured to extract, transform, and load the data into storage or warehouse with structure for future querying of historical data. One more APIs may be configured to enable users to collect and utilize agricultural data (e.g., both current and historical) across a smart city data network. An application-based software platform (mobile or web-hosted) for distributing analyzed and harmonized data may be implemented and a software platform allowing for the manipulation of collated data points and visualized in graphical model or statistical format to suit various application or planning needs may be provided.

According to one or more of the embodiments described herein, a smart city data network infrastructure may include the use of very high resolution optical, multispectral, SAR satellite, and/or aerial data. GIS may be used with layers indicating all rooftop agriculture in operation and all viable rooftops may be identified and earmarked for future development. Field gateways may facilitate data collection, compression, and filtering before the data is moved to the cloud. Cloud or cloudlet data centers may be configured to collect, analyze, and disseminate data from aerial/satellite imagery, while also decentralizing data storage and data processing. A data platform may securely capture, collate, and analyze a distributed network of agricultural and weather related data from farms throughout the city. Secure and accessible data and datasets may be segmented for various city departments based on needs and use cases. Both individual farm data and city-wide collective data insights developed through machine learning (ML) analytics may ensure city departments have visibility and predictability regarding crop yields or climate metrics and can plan policy or outreach accordingly. ML algorithms and neural networks may be implemented to transform cumulative data into patterns and predictions regarding city-wide crop health, yield forecasts, microclimate weather forecasts, and farm operations. One or more APIs may be developed for ease of collecting and distributing agricultural and microclimate data (both current and historical) across a smart city data network. Application-based software platform (mobile or web-hosted) may be used for distributing analyzed and harmonized data. A software platform allowing for the manipulation of collated data points and visualization of data in graphical models, or a statistical format may be used to suit various application or planning needs.

According to one or more of the embodiments described herein, a city-specific rooftop indexing and ranking system for agriculture implementation may be implemented. Such a system may comprise the use of very high resolution optical, multispectral, SAR satellite, and/or aerial data for remotely sensed imagery. LiDAR may be used for determining building height, volume, and useable area for rooftops. ML algorithms and neural networks may optimize and identify rooftop infrastructure based on multiple criteria decision analysis (MCDA). A digital roadmap including a custom GIS may index all available and viable rooftops in a given operational area, neighborhood, or city to enact a network of rooftop agriculture. Index parameters for a developed algorithm may include contiguous area, pitch, slope, building height, etc. A digital roadmap may also include a custom GIS ranking all available and viable rooftops in a given operational area, neighborhood, or city to enact a network of rooftop agriculture. Rankings may be displayed in a user interface according to minimum useable area calculations, or another subset of criteria related to city-specific data. One or more APIs may be developed for collecting and distributing data (both current and historical) across a smart city data network. An application-based software platform (mobile or web-hosted) may be used for distributing analyzed and harmonized data. An application-based software platform (mobile or web-hosted) for manipulating data or for toggling on and off layers of interest and for displaying information relating to desired criteria and overlapping of information.

According to one or more of the embodiments described herein, a city-specific roadmap for implementing three levels of rooftop sustainability measures may include a digital roadmap that includes a custom GIS classifying all available and viable rooftops in a given operational area, neighborhood, city. Layers of the GIS may include ratings indicating best options to implement one of three levels of sustainability projects. For example, to address albedo, GIS may be used to identify all dark rooftops that can be painted white for added energy savings through reflectivity. To address solar applications, GIS may be used to identify all viable rooftops for solar investment and deployment. To address agriculture application, GIS may be used to identify all viable rooftops, at or above outlined thresholds, for agriculture implementation. One or more layers may incorporate city-specific parameters like socio-economic factors, UHI, and food deserts (distance from rooftop to geographic point). One or more layers may identify and quantify existing urban rooftop green spaces or solar installations. One or more ML algorithms may utilize neural networks to index and create a ranking system based on an analysis of geospatial data, building information, and socio-economic inputs specific to a particular city. An application-based software platform (mobile or web-hosted) may be implemented for distributing analyzed and harmonized data. The application-based software platform may be utilized by a user for manipulating data or for toggling on and off layers of interest and to display desired criteria and view overlaps of information. The application-based software may also enable report generation with graphic and statistical display of quantitative information to support policy and decision making.

According to one or more of the embodiments described herein, a city-wide STEM education platform may include applications of school green roofs with areas designated for agriculture implementation including, for example, a technology platform comprising both hardware and software for STEM engagement. Such an embodiment may comprise the use of very high resolution optical, multispectral, SAR satellite, and/or aerial data for remotely sensed imagery. One or more IoT sensors, for remotely sensing data from crops, soil beds, and/or weather, or other any other related environmental source, may be deployed. Microprocessors, or other processing devices, may be used for AI analysis of collected sensor data. A normalized difference vegetation index (NDVI) algorithm may be configured and used to monitor crop health. A solar induced fluorescence (SIF) algorithm may be used to monitor crop stress. One or more field gateways may be implemented to facilitate data collection, compression, and filtering before the data is moved to the cloud. Cloud or cloudlet data centers may be used to collect, analyze, and distribute data originating from sensors and/or aerial/satellite sources, and to decentralize data storage and computational processes. A data lake or lakehouse may be used for storing captured IoT sensor data. ETL or ELT may be used for extracting, transforming, and loading the data into storage or a warehouse with structure for future querying of historical data. One or more APIs may be developed for ease of collecting and utilizing agricultural data (both current and historical) across a smart city data network. An application-based software platform (mobile or web-hosted) may be used to distribute analyzed and harmonized data. A school-targeted mobile or app-based software platform allowing for the manipulation of collated data points and visualization of data in a graphical model or statistical format to suit various application or planning needs may be implemented. A visibility across platform designated specifically for schools may enable users to monitor individual rooftop farm performance and metrics, as well as city-wide performance. A platform may display information related to resource utilization in school rooftop crop management and growing cycles. A platform may also display quantitative growth stages, yield expectations, and once harvested, alerts may be used to show direct benefit to the school lunch programs. Such an embodiment may create opportunities for visibility between a number of participating schools and promote healthy competitions for novel data usage and analysis, spin-off business opportunities, and community engagement.

According to one or more of the embodiments described herein, a city-wide green infrastructure or green project monitoring program may include the use of very high resolution optical, multispectral, SAR satellite and/or aerial data for remotely sensing imagery. One or more IoT sensors may be used for remotely sensing data from crops, green roofs, soil beds, green parklets, and/or weather or other any other related environmental source. One or more microprocessors or other processing devices may be used for AI analysis of collected sensor data. A normalized difference vegetation index (NDVI) algorithm may be used to monitor crop health, evapotranspiration (ET), and crop evapotranspiration (ETc) to quantify a rate of plant transpiration. Such data may be used to estimate or determine a cooling effect of green infrastructure projects. Sensors may monitor temperature of both air (urban heat island (UHI)) and soil, providing an indication of changes between the two data points, such as on an hourly or daily basis. Such data may provide an insight into irrigation timing and quantity, leading to more sustainable use of critical resources. One or more field gateways may be used to facilitate data collection, compression, and filtering before the data is moved to the cloud. Cloud or cloudlet data centers may be used to collect, analyze, and distribute data from sensors and/or aerial/satellite sources, while decentralizing data storage and computational processes. A data lake or lakehouse may be used for storing captured IoT sensor data. ETL or ELT may be used for extracting, transforming, and loading the data into storage or a warehouse with structure for future querying of historical data. One or more APIs may be implemented to ease of collecting and utilizing agricultural data (both current and historical) across a smart city data network. An application-based software platform (mobile or web-hosted) may be used for distributing analyzed and harmonized data. A software platform may allow for the manipulation of collated data points and the visualization of data in a graphical model or statistical format to suit various application or planning needs. The software platform may also be configured to generate reports with graphic and statistical display of quantitative information to support policy and decision making.

According to one or more of the embodiments described herein, a scalable program for identifying urban rooftops, developing agriculture, and/or fields, and for monitoring and measuring results of an urban carbon capture program. Such an embodiment may include, for example, the use of very high resolution optical, multispectral, SAR satellite, and/or aerial data for remotely sensing imagery. One or more IoT sensors may be used for remotely sensing data from crops, soil beds, weather and/or other any other related environmental source. One or more microprocessors or other processing devices may be implemented for AI analysis of collected sensor data. A normalized difference vegetation index (NDVI) algorithm may be configured to monitor crop health. A solar induced fluorescence (SIF) algorithm may be configured to monitor crop stress. A long term urban soil CO2 capture plan may be implemented based on a network of rooftop agriculture sites using rotational cover crop and non-tilled field methods. As used herein, an agriculture site may be a rooftop area capable of being used as a farm or garden. The term agriculture site may be interchangeable with agriculture space, agriculture site, farm, garden, etc. A network of sites may be measured both remotely via annual crop yields and locally through soil sampling via, for example, a third party. One or more field gateways may be used to facilitate data collection, compression, and filtering before the data is moved to the cloud. Cloud or cloudlet data centers may be used to collect, analyze, and distribute data from sensors and/or aerial/satellite sources, while decentralizing data storage and computational processes. A data lake or lakehouse may be used for storing captured IoT sensor data. ETL or ELT may be used for extracting, transforming, and loading data into storage or a warehouse with structure for future querying of historical data. One or more APIs may be developed for ease of collecting and utilizing agricultural data (both current and historical) across a smart city data network. An application-based software platform (mobile or web-hosted) may be developed for distributing analyzed and harmonized data. A software platform may allow for the manipulation of collated data points and the visualization of data in a graphical model or statistical format to suit various application or planning needs. The software platform may also be configured to generate reports which display quantitative carbon capture results of both individual rooftop sites and/or an entire urban agriculture network throughout a given area, community, city, or region.

### BRIEF DESCRIPTION OF THE DRAWINGS

FIG. 1 is an illustration of a smart city urban agriculture data management system 100 according to one or more embodiments of the present disclosure;

FIG. 2 is an illustration of an information flow diagram 200 for a smart city urban agriculture data network according to one or more embodiments of the present disclosure;

FIG. 3 is a flow chart of a method for developing the rooftop index and ranking system algorithms according to one or more embodiments of the present disclosure;

FIG. 4 is a block diagram of a data processing system or agriculture network data platform for smart city indexing, monitoring, and connecting rooftop data and transforming it into usable data for a multitude of user profiles according to one or more embodiments of the present disclosure; and

FIGS. 5-8 are flowcharts of methods according to one or more embodiments of the present disclosure.

Preferred features, embodiments, and variations of the technology may be discerned from the following Detailed Description which provides sufficient information for those skilled in the art to perform the technology. The Detailed Description is not to be regarded as limiting the scope of the preceding Summary of the technology in any way.

### DETAILED DESCRIPTION

As described above, mapping for viable rooftops to implement urban rooftop agriculture at scale is needed. An automated methodology is needed to develop a comprehensive dataset, scalable and effective in cities across the globe. Further, current models lack effective quantitative ranking criteria and protocols for agriculture development of urban rooftops.

Supervised classification for urban agriculture designation is not currently baselined. This is essential for determining existing green roof and agriculture rooftop sites and outlining future development goals for urban sustainability projects in conjunction with city specific economic, social, and environmental factors. Current rooftop evaluation models do not utilize the same benchmarks and standards for classification globally, as regional approaches and anticipated application outcomes vary.

Crop monitoring via sensors is a viable option in rural areas. Urban interfaces cause a host of issues surrounding latency and situational awareness regarding position, velocity, and time (PVT) and loss of sight (LOS). As well, network connectivity can be unreliable in urban areas, due to building materials and geometries, leading to delayed data sync schedules, which interferes with the near real-time transfer and analysis of both ground-based and space or air-based information.

Remote monitoring of urban infrastructure via satellite or aerial can be performed utilizing low to medium resolutions. Monitoring rooftop agriculture on a city-wide scale requires very high resolution (VHR) imagery due to intercropping (growing two or more crops within close proximity). Since each plant has its own spectral signature, the intermingling of crops can result in biological interaction, making health determinations difficult to accurately track and measure. Therefore, VHR imagery is highly useful in providing <1 meter spatial resolutions for precise data capture and analytics training and calculations with Normalized Difference Vegetation Index (NDVI) or Solar Induced Fluorescence (SIF) algorithms. VHR, medium resolution, and low resolution datasets may all be utilized to ensure continuity in data capture and assessment for monitoring crop growth, health, and yield forecasting.

Remote monitoring of non-contiguous fields/rooftops in an urban environment has not been attempted at a city-wide scale. Precision agriculture monitoring leverages geospatial data as a valuable tool for getting a complete picture of distributed fields. Those fields can be tens to hundreds, or even thousands of acres, which translate into time and money for a set of eyes to continually monitor all corners of the operations. Geospatial data with a temporal cadence of 12-24 hours provides complete and timely information about every field every day. The same application of coverage is not performed in urban areas, since city-wide rooftop farms at scale do not currently exist. However, despite the environmental difference, the elevation, and the more extreme example of non-contiguous fields, the monitoring aspects remain the same. Hence, the fields spread out over multiple rooftops comprise soil, crops, and weather at its core. Utilizing geospatial or UAV or aerial imagery can be leveraged to develop better, more sustainable, and more efficient agricultural and crop production outcomes for urban agriculture.

Some cloud-based platforms cause concerns related to latency, distribution, and scalability, particularly as the number of IoT devices connected to these networks continues to rise and the associated data bottlenecks form. The introduction of 5G and edge computing capabilities currently enable modest compute and storage at the sensor level, opening new opportunities to reduce latency and increase security. While some difficulty may be encountered regarding handling the full bandwidth of Ag-IoT data ingestion and ETL requirements locally, there are some interesting avenues the urban environment opens up regarding processing at the device level to reduce latency and enable near real-time compute and analysis of crop and weather data.

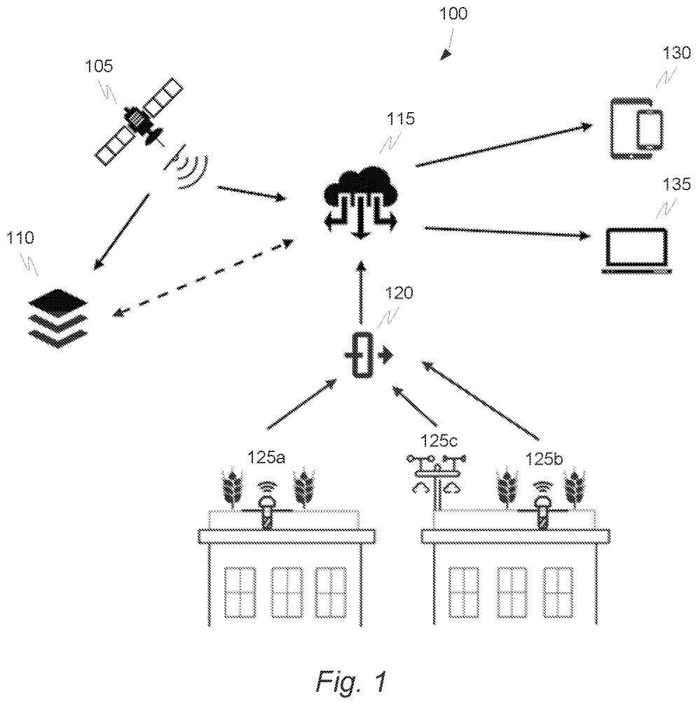

As illustrated in FIG. 1, an exemplary smart city urban agriculture data management system 100 according to one or more embodiments of the present disclosure may comprise a network 115 in communication with one or more computing elements. A smart city foundations may be based on an information and communications technology (ICT) framework. One exemplary aspect of the present technology relates to an IoT-enabled network of urban agriculture for smart city integration comprising three main components built on an ICT framework.

Indexing existing viable infrastructure for urban agriculture development may be performed using one or more satellites 105 to acquire multispectral data. Multispectral data may be used to create a viable infrastructure index for GIS 110. Satellite and aerial geospatial data packages may in some embodiments be provided by a third party vendor and/or other sources. The GIS platform may be maintained through a third party host or another provider. Data acquired by satellites 105 may be transmitted and processed through either a cloud or cloudlet network 115 for greater efficiency, though it should be appreciated other transmission and/or processing options may be used, such as by using one or more localized distributed networks. Data may move between the GIS 110 and the cloud 115 as new information and changes in remotely sensed data is collected in, for example, a 24-48 hour cadence, although any other collection cycle is possible.

Updates may be reflected in application-based platforms on user devices such as a smartphone or tablet 130 and computing devices 135.

Crop and soil sensors 125a, 125b and weather sensors 125c may be configured to collect data at a roof level. Data collected by crop and soil sensors 125a, 125b and weather sensors 125c may be processed either locally using on-board microprocessor and AI algorithms or after being transmitted through a field gateway 120 to the network 115 for interpretation and distribution to app-based devices. Results based on the processed data may be distributed to individuals within the network and/or to groups or managers of the network, with the data optionally being summarized, localized, geographically filtered and/or any other known method of presenting data appropriate for use by the user.

According to certain embodiments, sensors 125a, 125b, 125c may be plug and play compatible with the field gateway 120. The sensors 125a, 125b, and 125c may be able to transmit data with little configuration. As such, changing sensors and coupling with the field gateway 120 may be a straightforward process enabling changing sensors with little down time.

A smart city urban agriculture data management system 100 may be used by, for example, urban farmers reading daily crop metrics and leveraging predictive farming to reduce risks and increase efficiency and city governments leveraging collated and quantified metrics regarding food production and urban heat islands (UHI) at a number of sites and at city-scale. An app-based platform executing on user devices 130, 135 may be used to provide actionable and amplified metrics to be used, for example, for governing insights. Metrics generated through the systems and methods described herein may be metrics indicative of farming viability. For example, soil or air temperatures, precipitation levels, wind event data, air pressure change data, fertilization indicators, UHI temperature indices, etc. may each be a type of metric generated using sensor data as described herein which may be indicative of whether a particular space may be viable for farming purposes.

In some embodiments, a method involving a system 100 as described herein may begin with a satellite 105 which may be operated by a third party collecting geospatial data which may be input to a third party GIS platform 110. Visual and SAR data collected by the satellite 105 may be analyzed with an overlay of NDVI algorithms to classify all existing urban agriculture sites within designated city limits or other geographic boundaries.

A following layer of city data sets may be added to the GIS and may include metrics for analysis by an algorithm configured to identify viability of existing rooftops of a city for agriculture implementation. With the newly created layers of urban agriculture and viable rooftops, one or more entities such as a city planning commission or other city development departments may identify and establish a plan for implementing an urban agriculture network of rooftop farms. Ground truthing and engineering checks may be used to verify the validity of the remote and geospatial identifications.

Once agricultural sites are developed, one or more IoT-enabled soil and/or weather sensors 125a-c may be installed in or around soil beds at each site. For example, a rooftop garden may comprise one or more soil beds and each soil bed may include a separate soil sensor and a weather sensor may also be placed on the rooftop. One or more satellites 105 may be used to monitor and capture geospatial data relating to sites within a geographical region on a periodic rotation. Such data may be transmitted to a cloud-based network 115. Collected and sensed data may be transmitted from sensors 125a-c through a field gateway 120 to the network 115 and/or one or more cloud-based or cloudlet hubs. Next, the geospatial data may be analyzed with, for example, AI and/or NDVI algorithms to assess daily crop health. The field gateway 120 can operate as a collection point for the data and may pre-process and filter the data before transmitting the data to the cloud network 115.

The data may be updated in real- or near real-time or in intervals such as hourly, daily, or weekly, and may be accessed using on, for example, an app-based platform using a user device 130, 135, where a user such as a farmer will have access to the metrics outlined above. With those insights and analyzed data, resource application and management can be tailored to meet changing environmental conditions. In some embodiments, site-specific metrics may be provided to a farmer and each site's metrics may be distributed to a city's smart city data platform which may be accessed using a user device 130, 135, which may be an extension of an app-based platform for farmers.

Based on the data, recommendations may be provided to a farmer, such as water recommendations, fertilizer recommendations, crop recommendations, planting recommendations, harvesting recommendations, soil augmentation recommendations, collaborative farming recommendations, etc. Benchmarking data points like daily precipitation along with hourly temperature and humidity, leaf wetness, soil temperature, and evapotranspiration ETc can inform timing and duration of spraying—irrigation. A graphic user interface (UI) allows the farmer to plot each sensor's hourly data sync and derive actionable insight based on the near real-time information. If paired with a third party smart irrigation system, a series of parameters or trigger points can be set to initiate spraying automatically with targeted amounts in areas that fall below specified targets. Similarly, tracking growing degree days (GDD) or heat units, offers a way to estimate growth and development of both crops and pests. With the accumulation of average daily temperatures, there is a minimum development threshold that is required for growth. GDD is a more accurate way to anticipate crop development and predict yield, as well as anticipate timing of pest development. Therefore, the timing of any pesticide spraying can be better predicted and managed using the sensor's cumulative GDD data. High resolution NDVI imagery helps to alert farmers to potential issues, as higher numbers indicate a better greenness score. Lower numbers may indicate a stressed crop, due to either pest infestation or drought. This can alert farmers to spray fertilizers in the monitored areas or potential irrigation issues. The benefits of these actionable insights, means lower resource utilization and better efficiencies in growing. Finally, incorporating yield forecasting from all farms across the network will provide better planning for city agencies to allocate food appropriately. A decentralized PaaS will collate, analyze, and display daily updates across the network.

In some embodiments, a user may be a representative of a city or other form of municipality or entity and such a user may be described as a “city user.” The city user may be enabled to access data collected from a number of urban agriculture sites. For example, a city user may have access to data associated with all urban agriculture sites within a geographical area such as within the city limits. This data can be analyzed using machine learning configured to uncover trends and patterns in food production, temperature changes around the sites, cumulative and temporal changes to stormwater capture, and other microclimate metrics. Analysis data may be made available on a user's app platform and can be merged with other smart city data projects on a cloud management platform. The app platform may be a third party product.

The app-based platform may be a Platform as a Service (PAAS) or Software as a Service (SAAS) providing computer services for creating multi-level and multi-level access permissions for a community of users to participate in discussions, share insights into metrics, engage in virtual business or governmental hearings, such as where rights are granted. The PAAS may comprise a software platform for providing an on-line portal to review and manipulate data in predetermined categories or views, share and control data access with designated employees, engage in operational logistics, or conduct virtual multi-department meetings.

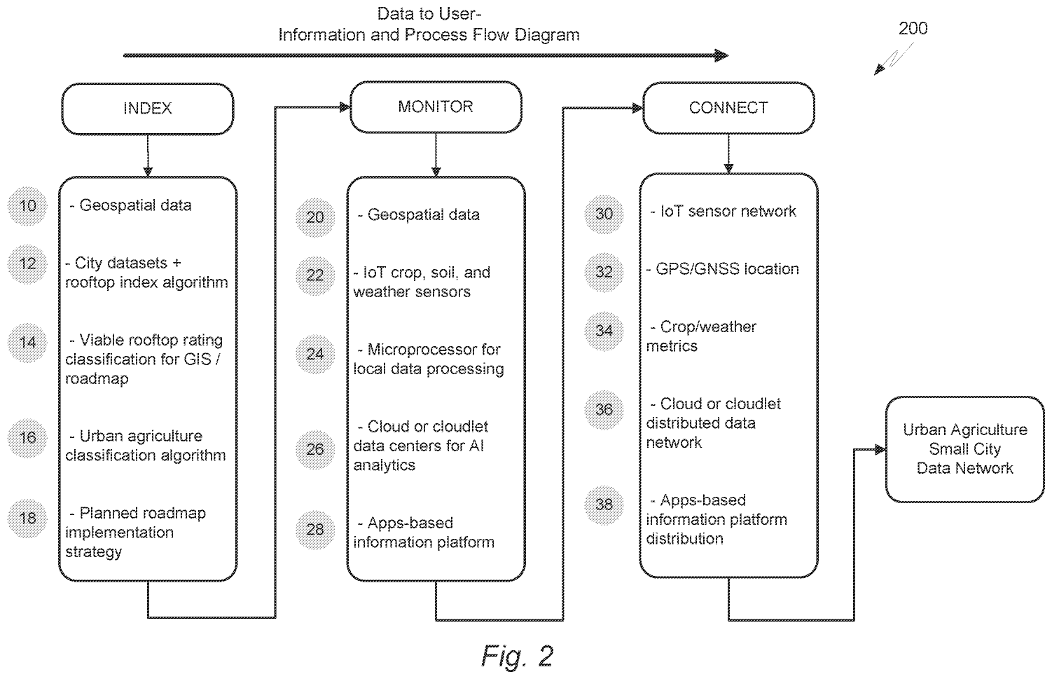

As illustrated in FIG. 2, a smart city urban agriculture data network may operate according to an information flow process 200. The information flow process 200 illustrates a cycle of data capture from an initial stage to a complete smart city data network platform and user application.

In some embodiments, a network may be associated with a group or set of agriculture units. An agriculture unit may be, for example, a rooftop garden. Each agriculture unit may be associated with one or more sensors. A network may require a minimum number of agriculture units and/or a minimum number of sensors. For example, in a particular exemplary embodiment, a minimum of three rooftops with a minimum of three sensors (one on each rooftop) qualifies as a network. The benefits of the smart city data network rest on the quality of the captured data, the analysis of the collated data, and the actionable insights derived and disseminated by the data. In short, a complete data platform allows a user to make informed decisions based on the insight derived from the three data components (index, monitor, connect).

The information flow process 200 may begin with a series of steps involving indexing data. At 10, geospatial data may be captured from one or more satellites or aerial devices. For example, single or multiple data points may be captured from aerial devices such as planes or drones or satellites. Optical data captured by aerial devices or satellites may be of a medium resolution between three to five meters. The geospatial data may next be transmitted to a cloud-based network and may provide a base layer for a customer's GIS and/or a roadmap for implementing an urban rooftop agriculture network.

At 12, local and city specific datasets such as zoning and cadastral information may be obtained from one or more data storage locations at 12. The local and city specific datasets may be combined with the geospatial data of 10 to enable a user such as a customer to cross-reference optical data from the geospatial data of 10 with building-specific details such as land or property ownership (public/private), building height, roof slope (e.g., less than 1:12), year built, and construction type. Using LiDAR data and building footprints, a series of algorithms may be developed to extract key features for the Index segment. Multiple-criteria decision analysis (MCDA) may be employed to develop weighted layers, and to allow the index to rank all viable rooftops, in a designated radius, for the specific function desired (e.g., addressing food security or climate resilience).

At 14, a classification system may be configured to identify and index all viable rooftops for urban agriculture development within the area represented by the geospatial data based on the combined geospatial data in the local and city-specific datasets. the identified viable rooftops may be integrated in a new GIS layer.

At 16, a layer of geospatial data analysis utilizing very high resolution (VHR) optical imagery (e.g., less than meter) may be incorporated. The VHR optical imagery may enable the employment of supervised classification techniques within the GIS system and may be used as a basis for a new standardized classification for urban agriculture. This dataset is an important marker for establishing existing food production pathways and capabilities in the customer's geographic area.

With the previous elements, a planned urban agriculture network implementation strategy can be designed and deployed at 18. Using the newly developed GIS layers for viable rooftop index and existing urban agriculture as a guide, sites for agriculture development can be identified and prioritized based on spatial information and relationships.

The second component of the urban agriculture smart city data network is monitoring the indexed data. Once urban rooftop farms are operational, each may require constant management and monitoring via remote and ground-based approaches. Additionally, captured, and processed data may be transmitted back to a decentralized smart city network at intervals or in real-time or near real-time for further study and evaluation of the combined metrics.

In some embodiments, scalar viewing may be implemented using very high resolution (VHR) optical, multispectral, hyperspectral, and/or synthetic aperture radar (SAR) resolutions. At 20, sub-meter optical resolutions, multispectral resolutions in the near infrared (NIR) wavelengths, and SAR may be incorporated for monitoring crop health.

Optical resolutions may be used to provide a visual field, multispectral (NIR) may be used to provide a basis of crop health algorithms (NDVI), hyperspectral may be used to provide a basis for SFI, and SAR may be used to provide around the clock, rain-or-shine radar images which are also valuable for crop health monitoring. Geospatial data and IoT sensor data may be extracted using ETL/ELT or similar data architecture to store or warehouse in, for example, a data lake or lakehouse for future querying and analysis.

On the ground, one or more sensors may be used to collect data. In some embodiments, each agricultural space, such as a rooftop, may comprise a minimum of one sensor or a group of sensors. The sensors may be configured to take readings of various crop data points on an interval, such as hourly or daily, or in real time. At 22, the data points from the sensors may include some or all of the following: soil moisture, soil pH levels, leaf health, growth measurements, evapotranspiration, temperature, humidity, wind speed, wind direction, solar radiation/UV, rain collection levels, air quality (micro-particle counts), etc.

Sensor data may be processed in a variety of ways. In a first scenario, data may be processed at 24 via a processing device such as a microprocessor on a IoT sensor device comprising the sensor. For example, an IoT sensor device may comprise a sensor such as a soil sensor. The IoT sensor device may further comprise a processor, memory, input/output, and other computing device components. By including a processor within the IoT sensor/device, latency, energy usage, bandwidth issues, and security concerns relating to long-range data transmission may be reduced. In such an embodiment, algorithms can be loaded directly onto the IoT sensor device. For example, a processor on an IoT sensor device may be configured to process sensor data according to an algorithm for crop health monitoring. The algorithm for crop health monitoring may include, for example, a normalized difference vegetation index (NDVI):

$$N D V I = \frac{N I R - R E D}{N I R + R E D} .$$

Using a sensor as part of an IoT sensor device may be particularly applicable to urban areas in which networks such as 5G networks are implemented and which may enable edge computing to be a valid option for data capture and analysis.

In some embodiments, instead of or in addition to processing sensor data using a processor of an IoT sensor device, data may be transmitted from a sensor to a field gateway which may broadcast data to a cloud or cloudlet at 26 where the data may be collated, analyzed, and disseminated via an application based software. Such an embodiment may be more widely applicable to cities with variable levels of data bandwidth.

IoT sensors may be configured to transmit data to one or more satellites where possible and/or to a field gateway before the cloud network. In some embodiments, the IoT sensors may be configured to transmit data at, for example, 700 to 2600 MHz on the NB-IoT network and/or 868 to 915 MHz on the LoRa network. Processed data may be disseminated to one or more users through a digital application-based platform at 28. The digital platform may be configured to provide forecast metrics, such as hourly, daily, and/or weekly metrics, and also site-specific and/or collated total platform metrics. Such metrics may include, for example, a list of each monitored site showing location data, current or past temperature and precipitation levels; a monthly outlook with daily temperature and rainfall predictions for each site; a map view with fixed location pins for each monitored site; weather alerts for temperature spikes, wind event data, air pressure change data; urban field and/or rooftop soil mapping, hydrology mapping, and crop modelling; fertilization indicators; a UHI temperature index; user input for ground-truthing remote monitoring data; a cumulative time-based analysis of location specific metrics across all inputs; etc.; and/or some combination thereof

In some embodiments, the collected aerial/satellite data may be merged and analyzed with IoT sensor data and used to generate a reduced risk asset management tool for urban farmers and/or an application based circular data platform for a user to measure smart city project metrics.

The third component of the urban agriculture smart city data network is connected. An IoT sensor network may be achieved at 30 through reaching a minimum viable number of agriculture locations such as rooftops and/or a viable number of sensors. In a particular embodiment, the minimum number of agriculture locations and the minimum number of sensors is three, but the maximum is unlimited. in such an embodiment, three sensors on three separate rooftops forms the minimum network for feedback and data parameters.

At 32, GPS and/or GNSS may be used to determine a location of each sensor. Location determination represents one of the most energy-intensive processes in IoT sensor devices in an urban context. Due to off-nadir viewing angles with multi-height buildings, PVT may be cycled on and off repeatedly due to LOS. As such, the PVT may be transitioned off of the IoT sensor device and into a cloud-based or cloudlet ecosystem which may save immense battery energy. As battery life contributes to low Return on Investment (ROI) with frequent change throughout the sensor's lifetime, the systems and methods as described herein can remove the GPS computing power off of the chip-based sensor thus improving energy efficiency. The sensor's battery can then instead be used for transmitting crop, soil, and weather metrics for analysis by various AI algorithms.

The sensor data may be used to generate crop and/or weather metrics at 34. Sensor data as described herein may be utilized by, for example, urban farmers—for efficiencies in growing and resource utilization—and for customers such as cities—for measuring sustainability goals within smart city projects in regard to food production and climate resilience.

Further, cumulative data effects can be amplified by incorporating additional rooftops/data or by offering data to adjacent customers using one or more cloud or cloudlet distributed data networks at 36. At 38, the application-based platform may be used to provide users a user interface or dashboard for site-specific and/or city-wide metrics. Such metrics may include, for example, city-wide UHI reductions, stormwater capture information, and microclimate data.

Through the use of an information flow process 200 via a smart city urban agriculture data network as illustrated in FIG. 2, users may be enabled to leverage cumulative data as described herein to shape future zoning regulations, future smart city development projects, and collaborations between private and public businesses.

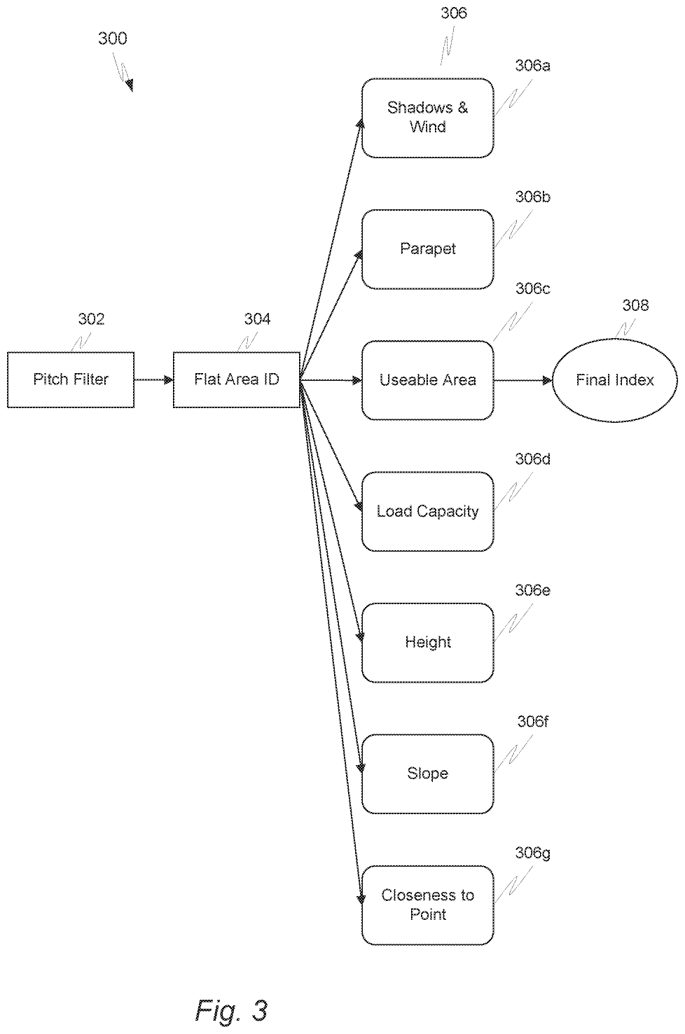

As illustrated in FIG. 3, a method 300 for developing a rooftop index and ranking system according to an embodiment of the present technology. The rooftop index and ranking system may index and rank agricultural spaces, such as rooftop farms, based on an order of magnitude for meeting and/or exceeding a prescribed list of criteria. Such a system may provide a key to developing a city roadmap for agriculture implementation. Ideal locations for agricultural spaces may be identified and ranked using a method 300 as described herein. The method 300, as described below, may implement one or more machine learning algorithms, and may be used by a user such as a city government using a city-specific GIS via digital software and/or applications.

To develop a comprehensive algorithm capable of indexing and ranking existing rooftop infrastructure in a designated urban environment, a system such as an artificial intelligence model, machine learning training model, neural network, or other system, may be configured to filter out desirable attributes from undesirable attributes. Training datasets currently exist for different types of roof feature detection. A pitched roof detection dataset may be used to train a machine learning model to identify flat roofs and pitched roofs in image data. The pitch filter may, in some embodiments, be a custom algorithm pipeline configured to use LiDAR data to filter out any roofs that are not flat. First, LiDAR elevation data may be converted to slope using a geospatial data abstraction library. The geospatial data abstraction library may be configured to read metadata and process raster and vector geographical data and may be used to develop a GIS roadmap. A given rooftop may be classified as flat if the number of pixels on the given rooftop that are less than or equal to a slope threshold make up more than an area threshold, which may be represented as a percent of an area of the rooftop. The slope threshold may be a hyperparameter defining the slope (e.g., in degrees) at which a pixel may be considered to be flat. The area threshold may be a hyperparameter defining the percentage of pixels on a rooftop which must be flat in order for a roof to be considered flat. The pitch filter algorithm may be configured to convert all slope values greater than the slope threshold to zero, and everything else to one. If a pixel's slope is determined to be greater than the slope threshold of x degrees, zero is assigned, otherwise one is assigned. If greater than x% of the pixels on the rooftop have a value of 1, the roof may be classified as flat, otherwise the roof may be classified as pitched. As used herein, x degrees and x% are hyperparameters that are likely to change from city to city. To determine a flat area, the sum of the pixels and area are calculated. Zonal statistics are then calculated, before extracting flat areas from the statistics. Building and flat area spatial polygons may next be merged before the total flat area is calculated. Buildings whose flat area is less than a threshold square footage may be filtered from results. As used herein, a machine learning model may be an artificial intelligence model, a neural network, a convolutional neural network, or any type of system trained using training data to generate outputs.

At 302, a trained machine learning model or algorithmic data pipeline (Flat Area ID (FAID)) may be used to identify flat roofs. The FAID may in some embodiments be one or more algorithms and may employ a neural network. Based on LiDAR data, the FAID may be used to identify areas within a building footprint that are flat and greater than a specified minimum square footage. Output of FAID may be vector data such as a shapefile with an attribute that connects each polygon to a building footprint. To find contiguous flat areas, a raster of building height may be smoothed with a gaussian filter to remove any pits, and a raster of slope may be masked to one if slope is less than a particular angle, such as 45 degrees, and zero if the slope is greater than a particular angle, such as 45 degrees. These two new rasters may be multiplied and filtered to remove pixels that are smaller than a particular area, such as five square feet. The raster may then be converted to polygons with a region growing algorithm and intersected with a building footprint vector to create a vector of contiguous flat areas within building footprints. Finally, this new vector may be filtered to remove flat areas smaller than a specified square foot minimum.

In some embodiments, LiDAR data may be used to establish hyperparameters such as a slope or angle threshold and an area or size threshold. For example, the model may determine a roof is flat based on a determination that pixels on a given rooftop are less than or equal to a slope threshold.

At 304, the flat roofs identified in 302 may be further analyzed to determine whether a roof meets a size or area threshold. Area threshold analysis may be used to define a percentage of pixels which must be flat in order to consider a roof as a flat usable area. Based on the determination that pixels are of a flat roof which meets or exceeds an area threshold, vector data may be derived.

The vector data derived from element 304 comprises a baseline for a series of multi-decision criteria assessments at elements 306a-g. Each feature layer represents a separate algorithm which may be used to derive accurate and measurable information used in a complex selection process. Feature layers may, for example, include the following: usable area, slope, load capacity, load volume, building height, closeness to a point, parapet, etc.

For example, an algorithm or AI system may be configured to calculate shadows and/or wind in input image data at element 306a. are easily incorporated into both MCDA layers and GIS layers.

At 306b, a parapet detection algorithm may be used to calculate a change in slope at a determined offset from a building perimeter based on the slope threshold derived at 302. The parapet detection algorithm starts by making a gdf representing a boundary of the buildings in question as well as making a gdf representing a one-meter buffer around the inside perimeter of the building. The two gdfs may be joined to make a ring polygon around the edge of the building. The ring polygon may be used to locate the parapet. Next, the median slope of the outer edge of the building may be calculated. Median slope values may next be added to each polygon and the parapet slope may be calculated. The parapet slopes may then be added to the building gdf. Any remarkable change in slope detection at the parapet location can determine if a parapet exists. Because parapets may provide substantial shielding from increased winds at elevation and provide a safety feature for potential rooftop windblown hazards, the parapet detection algorithm may be of use for selecting viable rooftops.

At 306c, a shapefile reflecting contiguous flat areas meeting a minimum criteria for establishing a rooftop farm may be derived based on the vector data generated at 304. In some embodiments, slope, building footprint, area, and/or other factors may be used to derive the shapefile. Usable area may be derived from each unique FAID. For a given FAID polygon, the area attribute may be extracted from a .shp geometry and multiplied by 10.7639 to convert from m\hat{ }2 to ft\hat{ }2. The raster data may next be polygonized using a region growing algorithm. A filter may be used to identify flat areas from the slope threshold, convert flat areas into polygons, spatially join buildings and flat areas, and convert all multi polygons into individual polygons. Area may next be calculated and any polygons under a minimum square foot threshold may be removed.

At 306d, a load capacity may be determined from the vector data generated at 304 in addition to building footprint data. For example, a load capacity may be determined by calculating an inverse of the flat area by performing a spatial difference between the flat area and each building footprint. The height and area of each of the resulting polygons may be calculated and multiplied as an estimate of volume (provided an assumption that all objects on the rooftops are rectangular). Finally, the volume of all objects on a given building may be summed to generate a total estimate of volume on a rooftop. Cross-referencing the resulting volume against building data, e.g., construction type and year built, the resulting algorithm may be used to provide an estimate for a structural load capacity of the building rooftop. In some embodiments, the volumetric and load capacity findings may be corroborated via a licensed structural engineer to assess the exact weight per square foot of load capacity for each building, including calculations of dry and/or wet loads of additional soil medium, crops, mechanical equipment, etc.

Building height 306e a may be determined using a composite of LiDAR data. The LiDAR data may be combined with the flat usable area developed in 304 to determine slope 306f. The closeness of any given building identified previously through element 304 to any geolocated point may be determined. based on FAID and point data in vector format. For a given FAID and a vector of points, a minimum distance to a point from the centroid of the FAID may be determined. Closeness to a point (306g) may be used to provide a city with points of interest (POIs) or distance from a POI to aid in the decision-making when choosing building sites. For example, if the index locates a series of buildings across a municipality, a GIS roadmap may include different layers of information. Some layers of information may indicate socio-economic indicators, average temperatures, fresh food locations, green space, etc. Closeness to a point may allow for any building in the index to be located within the above layers of information and for a distance to be calculated to better inform decisions. For example, priority may be given to a building site that is far from any green space, has higher temperatures than the city-wide average, and has few fresh food and/or grocery options in its vicinity.

Different weighting criteria may be used in MCDA to determine the desired point and distance from buildings of interest identified as viable development candidates. Such criteria may be different for each city or user, and the weighting system may be capable of being tuned as needed to display the most pressing issues for a municipality (e.g., distance from fresh food/store, distance from nearest green space, etc.). This list is by no means exhaustive, and one or more of these criteria or others not listed may apply.

Incorporating these different features and elements as critical layers of the MCDA as described herein may enable an index of rooftop gardens to be tuned and for highly accurate results to be delivered. The results may form the basis for a custom roadmap to be provided to cities, private industries, communities, and farmers in the forms of one or more of an interactive, editable, and scalable GIS, using layers of inputs that represent building characteristics, socio-economic factors, microclimate data, viability for measurable environmental impact, etc.

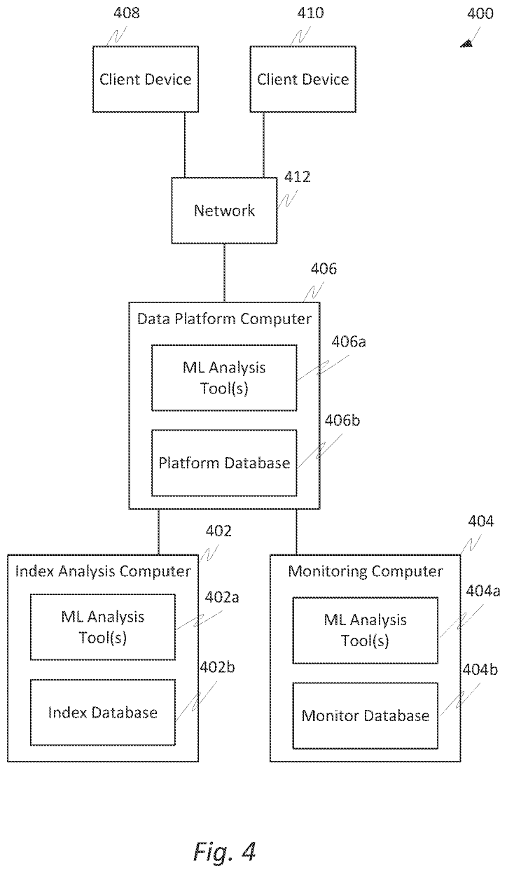

FIG. 4 illustrates a data processing system or agriculture network data platform 400 for smart city indexing and monitoring and transforming rooftop data into usable data for a multitude of user profiles for use with the methods and systems consistent with the present embodiment. The data processing system 400 consists of a plurality of computing devices: an index analysis computer 402, a monitoring computer 404, a data platform computer 406, and client devices 408, 410. Each computing device may be capable of connecting to a network 412, via cloud or other means. Each of the index analysis computer 402, monitoring computer 404, data platform computer 406, and client devices 408, 410 may be, for example, a personal computer, tablet, mobile device, server, or other types of computing devices. The network 412 may include several networks, including but not limited to local area networks or wide area networks, hard-wired, wireless, etc. The network 412 may be considered the Internet for illustrative purposes. Each of the index analysis computer 402, monitoring computer 404, data platform computer 406, and client devices 408, 410 may be connected to the network via an appropriate communication link.

The index analysis computer 402, monitoring computer 404, and data platform computer 406 may operate as technology segment analysis tools and databases for a smart city data platform. While FIG. 4 illustrates the index analysis computer 402, monitoring computer 404, and data platform computer 406 as being separate computers, it should be appreciated each of the index analysis computer 402, monitoring computer 404, and data platform computer 406 may reside on a single machine or a multitude of machines. Each of the index analysis computer 402, monitoring computer 404, and data platform computer 406 may comprise a machine learning analysis tool used to derive information specific to the segment, whether it is an index and ratings algorithm, IoT crop and weather data sync and historical analysis tools and algorithms, or platform database tools which search for patterns across the full data network, collating collected data, and processing real time decision making reports and graphical analysis.

For example, an index analysis computer 402 may comprise one or more machine learning analysis tools 402a and an index database 402b. The index database may host information relating to one or more city specific indices, roadmaps, GIS, or other ranking classification systems. Information hosted by the index database may relate to the identification of building assets as outlined in FIGS. 2 and 3. The index machine learning tools may be warehoused or employed to derive patterns across the entire database. Such patterns may include, for example, changes in availability of rooftops for development within a given city, changes to the identification and ranking algorithm employed in identifying and ranking the rooftops, changes in infrastructure viability across multiple cities, and patterns of development across multiple cities. The analysis may result in graphic information, report generation, or periodic GIS map changes. The monitoring computer 404 may comprise one or more machine learning analysis tools 404a and a monitor database 404b. Similar to the index database 402b and analysis tools 402a, the monitor database 404b may warehouse all or some of the data collected via IoT farm based sensors and geospatial intelligence across a city's network of farms, as well as from some or all cities in a portfolio. The monitor machine learning analysis tools 404a may host and/or analyze aggregated farm data (sensor and geospatial) for one or more farms across one or more cities, and/or host and/or analyze aggregate data across multiple cities for developing statistical and quantitative benchmarking by region, state, or country. The data platform computer 406 may comprise one or more machine learning (ML) analysis tools 406a and a platform database 406b. The platform database 406b may represents the PaaS that delivers city-wide visibility into the agriculture network ecosystem and may connect with other smart city initiatives or programs. The UI may include GIS, roadmaps, the index, or additional inputs from outside data as well as integrated, analyzed, and forecasted crop information and metrics and microclimate data. Projections or estimated yields across a city-wide network may be warehoused for querying. The ML analysis tools 406a may include graphics, reporting, statistical analysis, or other methods to determine food security, climate mitigation efforts and any associated patterns across local or regional geographic areas, and/or to derive quantitative measurement of the combined cities metrics in a state, country, and/or global level.

Each of the index database 402b, monitor database 404b, and platform database 406b may comprise sufficient data architecture which stores or warehouses the transformed data for future querying, depending on the current or future allocation of data needs.

In a certain embodiment of the present technology, the data platform computer 406 may be configured to generate a user interface including one or more tabs to allow a user to access summarized, compared, or predicted crop data, weather metrics, crop yields, and/or other data points, such as on an hourly or daily basis or in real-time, on one or more farms in the network. The summary may be available through a GUI and/or statistical displays. The data platform computer 406 may be further configured to generate reports containing such information. The reports may be transmitted to one or computer systems such as client devices 408, 410.

The data platform computer 406 may also allow a user to leverage the data and initial GIS to visualize and plan for the areas of implementation, building sites, and schedule of milestones. As the city scales, the platform, and the GIS scale with it, adding to existing layers as well as developing new layers that impact the platform's reach.

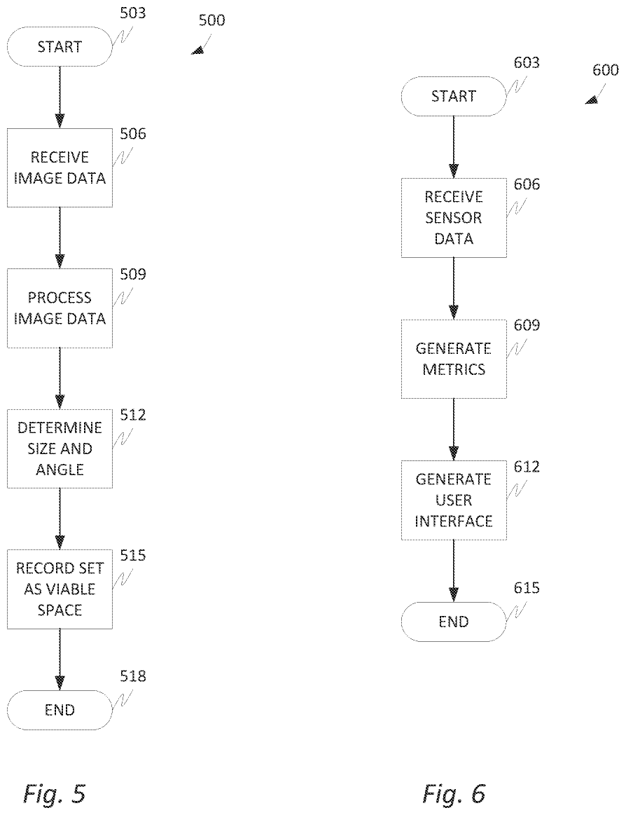

As illustrated in FIG. 5, in some embodiments a method 500 of determining sites or spaces viable for agriculture may be implemented using one or more of the systems as described herein. The method 500 may be implemented to determine viability of rooftops within an urban environment for growing crops, although it should be appreciated the same or similar methods may be implemented for other environments and for spaces other than rooftops, such as yards, parking lots, parks, etc. The method 500 enables geospatial optical resolutions, multispectral resolutions, and SAR data to be harmonized with NDVI algorithms to create new urban agriculture and building viability classification layers for GIS.

The method 500 may start 503 with a system 100 such as illustrated in FIG. 1 and described above. One or more satellites 105 may be deployed and may be configured to capture image data as described above. The satellites 105 may acquire multispectral data. It should be appreciated that in some embodiments devices other than satellites 105 may acquire the data, such as planes or drones, or the data may be acquired from one or more databases such as third-party image resources available on the Internet.

At 506, image data may be received by a computer system such as a computing device 135 or a user device such as a smartphone or tablet 130. The image data may be, for example, geospatial data received from a satellite.

In some embodiments, additional data may be received. For example, along with the image data, the computer system may receive or acquire a dataset associated with a city or other type of geographical location.

At 509, the received image data may be processed using, for example, an artificial intelligence (AI) or machine learning (ML) model. As described above, a model may be trained to detect pixels from within one or more input images corresponding to potential rooftops or other sites which may be viable for agriculture production. For example, groups of pixels may be recognized as being of a relatively flat space.

At 512, a computer system may be configured to determine, based on the processing of the image data using the AI or ML model, a set of pixels of the image data meets a size threshold and an angle threshold. Whether a size threshold has been met may be determined based on a determination of whether an input image contains a particular number of connected pixels representing a certain land-size, such as measured in square feet or acres. Whether an angle threshold has been met may be determined based on a determination as to whether the object, land, building, etc., represented by the connected pixels meeting the size threshold is relatively flat or of a sufficiently minimum slope as to be viable for agriculture. In some embodiments other factors, as discussed above in relation to FIG. 3, may be determined, such as estimating a load capacity associated with the set of pixels, determining whether the set of pixels is surrounded by a parapet, etc.

Based on determining a connected set of pixels meets a particular size threshold, angle threshold, and/or other factors, the set of pixels may be recorded as a viable agriculture space at 515. Recording the set of pixels may in some embodiments comprise updating an index as described above.

A method 500 as described herein may be used to quickly and efficiently identify and investigate viable spaces within an area for agricultural purposes. Such a method 500 may be particularly useful to determine spaces such as rooftops within an urban area for rooftop farming. Identifying urban areas which are viable for farming, gardening, or otherwise growing crops may be useful to, for example, a city government.

At 518, the method 500 may end. In some embodiments, an application platform may be used to provide descriptions of areas recognized as viable to one or more users. An application platform may enable city government departments to hold one or more subscription seats which may allow for variable data layers within a user interface of the application platform to be activated or deactivated, depending upon the nature of the use case and predetermined criteria designating the data usage, e.g., building departments, planning departments, parks departments, smart cities, IoT, ICT, etc. It should be appreciated the list of described city departments is meant to be neither exclusionary nor exhaustive regarding possible departmental interest or usage of the collected and harmonized data. Data generated in a method 500 as described herein may be utilized and leveraged for current or future developments differently across one or more departments. A custom city GIS may be used throughout different departments and the application platform may provide for the ability to toggle between visible and application-specific inactive layers. As deemed necessary, such layers may be visible to desired parties across multiple departments, farms, private business, communities, schools, institutions, etc. In some embodiments, access to the data may be managed through a data platform by a developer, by a designated department manager, or other party assigned at a time of subscription to services.

As illustrated in FIG. 6, in some embodiments a method 600 method 600 of monitoring space used for agricultural purposes, such as one or more rooftop farms or gardens or other spaces within an urban environment, may be implemented using one or more of the systems as described herein.

The method 600 may start 603 in which one or more sensors 125a, 125b positioned in or near an agricultural site, such as a rooftop farm, may be deployed. The sensors 125a, 125b may be, for example, weather sensors such temperature, humidity, wind, etc., soil sensors, or other types of sensors. The sensors 125a, 125b may be installed near an agricultural site or in the soil. In some embodiments, a plurality of sensors 125a, 125b may be associated with a single agricultural site such as one garden or may be associated with a plurality of agricultural sites such as a plurality of rooftop farms.

At 606, a computer system may receive data from the one or more sensors. The data may be received by the computer system in a raw form such as raw sensor data or may be received following processing such as processing by a processor device associated with each sensor. For example, a sensor may be a part of a sensor device containing the sensor as well as a computing device. Whether the sensor data is received in a raw form or in a processed form, the computer system receiving the data may perform further processing of the data.

In some embodiments, the computer system receiving the data may be configured to determine a location of the one or more sensors from which the data is received. The data may be received from the one or more sensors via a field gateway 120 in communication with a network 115 as illustrated in FIG. 1. Each sensor may be associated or in communication with one or more transmitters which may be configured to send sensed data to a field gateway. Such transmitters may include, for example, cellular (NB-IoT, LPWAN, LoRa WAN or LTE-M) data or Wi-Fi network capabilities. Each transmitter may be configured to transmit collected data via a cellular data or one or more Wi-Fi networks. In some embodiments, the data may be received along with location data or may be received along with data identifying the sensor from which the data originated. Determining a location of the sensors from which the data is received may comprise identifying the sensor and performing a data lookup using an identity of the sensor to determine a location of the sensor based on a table, list, index, or other form of data.

In some embodiments, in addition to receiving sensor data, the computer system may also obtain image data such as VHR (<1 m), geospatial optical resolutions, multispectral or hyperspectral resolutions, and/or SAR data,

Based on the received data, one or more metrics may be generated by the computer system at 609. The metrics may be associated with the agriculture space with which each sensor is associated. In some embodiments, the computer system may also generate one or more recommendations based on the data received from the one or more sensors. For example, AI analytics, NDVI algorithms, SFI algorithms, or other system adapted to process any crop and/or micro-climate data may be configured to generate an output distributable to one or more users such as farmers. The output generated may include, for example, one or more recommendations based on the analyzed data.

In some embodiments, a plurality of agricultural sites, such as urban agriculture rooftops, may be interconnected digitally such as to form an urban agriculture network. An urban agriculture data network may thus be driven by IoT sensors, and the network can be integrated into one or more smart city networks and a circular data network can be formed. a cloud based data analysis platform adapted to receive and analyze the data. In this way, a plurality of farms or other types of agricultural sites, each collecting and distributing data to a cloud or cloudlet infrastructure, may, for example, contribute to a pooled and anonymized data platform. Access to the pooled and anonymized data may be distributed across public and private entities such as subscribers in good standing to a data network.

At 612, a user interface comprising the generated metrics may be generated. The user interface may comprise a summary of data associated with the sensors from which the data was received. The user interface may also comprise any recommendations generated by the computer system. Using an application platform such as a decentralized application-based, web or mobile, data platform, the generated recommendations and metrics may be disseminated to a number of users. After generating the user interface, the method 600 may end 615. The processes and techniques disclosed herein have been described above as a series of steps. However, one or more of the steps can be optional and may be skipped. Additionally, the steps can be performed in a different order and/or by other entity/entities than described above.

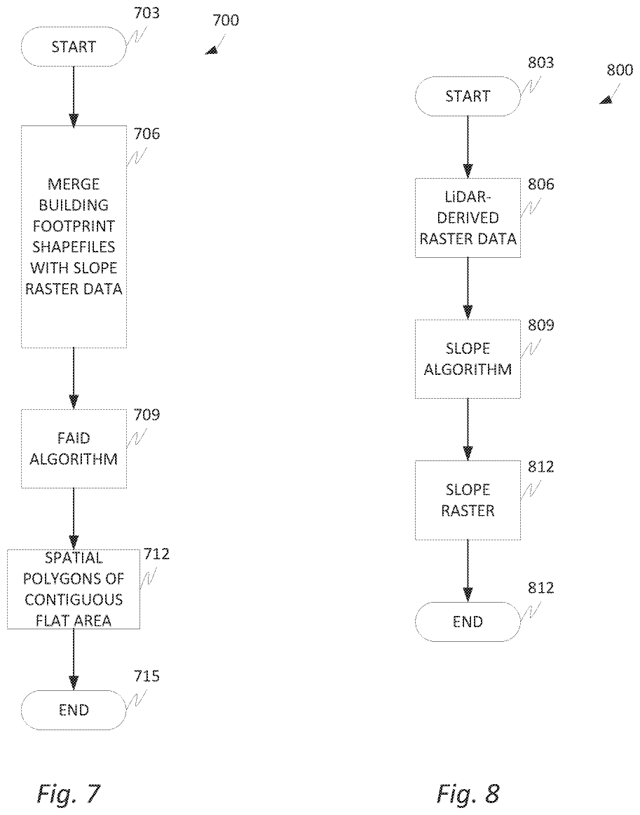

As illustrated in FIG. 7, in some embodiments a method 700 of determining a minimum viable threshold of contiguous flat roof area for agriculture development (FAID) may be implemented using one or more of the systems as described herein. Building footprint shapefiles and slope raster are passed through an FAID algorithm to produce a shapefile of FAIDs.

The method 700 may start at 703 in which several types of building datasets are merged to calculate usable area, including, but not limited to: vector building datasets, national rasterized building datasets, or commercially available building footprint shapefiles.

At 706, building footprint shapefiles may be merged with slope raster data. Slope raster data may be determined by using LiDAR-derived raster of elevation as an input and passed through a region growing algorithm where rasters are converted to polygons. or the raster package function may be used to compute plot slope and aspect for each pixel. A mean value of slope is calculated across all pixels within an FAID.

At 709, contiguous groups of flat pixels may be grouped together and vectorized using a region growing algorithm. Spatial join may then be used to merge these regions with the building footprints to create the FAIDs and calculate the usable area at 712. The method 700 may end at 715.

As illustrated in FIG. 8, in some embodiments a method 800 of determining a slope raster used in calculating FAID, may be implemented using one or more of the systems as described herein.

The method 800 may start with 803 in which a computer system may receive LiDAR data from a source such as one or more of an internal database, a remote database, and a cloud-based database.

LiDAR-derived raster of elevation data 806, representing the study area, may be processed through a geographic data abstraction library processing library. For example, a formula to calculate slope in degrees from elevation data, arctan(rise/run), between adjacent pixels may be employed. The slope algorithm 809, may use the above function to create a slope raster at 812 to be used in determining the FAID in the method 700 and the usable area in 306e as described above. The method 800 may end at 812.

Benefits, other advantages, and solutions to problems have been described herein regarding specific embodiments. However, the benefits, advantages, solutions to problems, and any elements that may cause any benefit, advantage, or solution to occur or become more pronounced are not to be construed as critical, required, or essential features or elements of the disclosure.

No claim element herein is to be construed under the provisions of 35 U.S.C. Section 112, sixth paragraph, unless the element is expressly recited using the phrase “means for.”

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc. WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); IEEE-802.11REVmc (“IEEE 802.11-REVmcTM/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.1lay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)), IEEE 802.11-2016 and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.5, August 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, or operate using any one or more of the above protocols, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, a drone, a communications enabled drone or UAV, or the like.

Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

Some demonstrative embodiments may be used in conjunction with a WLAN (Wireless Local Area Network), e.g., a Wi-Fi network. Other embodiments may be used in conjunction with any other suitable wireless communication network, for example, a wireless area network, a “piconet,” a WPAN, a WVAN, and the like.

Some demonstrative embodiments may be used in conjunction with a wireless communication network communicating over a frequency band of 5 GHz and/or 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 GhH and 300 GHz, a WLAN frequency band, a WPAN frequency band, a frequency band according to the WGA specification, and the like.

While the above provides just some simple examples of the various device configurations, it is to be appreciated that numerous variations and permutations are possible.

In the detailed description, numerous specific details are set forth in order to provide a thorough understanding of the disclosed techniques. However, it will be understood by those skilled in the art that the present techniques may be practiced without these specific details. In other instances, well-known methods, procedures, components, and circuits have not been described in detail so as not to obscure the present disclosure.

Although embodiments are not limited in this regard, discussions utilizing terms such as, for example, “processing,” “computing,” “calculating,” “determining,” “establishing,” “analyzing,” “checking,” or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more.” The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, or within a dedicated secured, unsecured, and/or encrypted system and/or within a network operation or management device that is located inside or outside the network.

Thus, it should be appreciated that the components of the system can be combined into one or more devices or split between devices. As will be appreciated from the following description, and for reasons of computational efficiency, the components of the system can be arranged at any location within the environment without affecting the operation thereof.

Furthermore, it should be appreciated that the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeably and include any type of methodology, process, technique, mathematical operational or protocol.

The systems and methods disclosed herein can also be implemented as instructions on a computer-readable information storage media that when executed by one or more processors cause to be performed any of the above aspects disclosed herein.

Embodiments of the present disclosure include a method of determining agriculture space viability, the method comprising: receiving image data; processing the image data with an artificial intelligence model; determining, based on the processing of the image data, a set of pixels of the image data meets one or more thresholds associated with agricultural viability; and based on determining the set of pixels meets the one or more thresholds, recording the set of pixels as a viable agriculture space.

Aspects of the above method include wherein the one or more thresholds comprise one or more of a size threshold and an angle threshold.

Aspects of the above method include the method further comprising identifying the set of pixels as a rooftop.

Aspects of the above method include wherein the agriculture space is a rooftop.

Aspects of the above method include wherein the image data is geospatial data received from a satellite.

Aspects of the above method include the method further comprising, prior to recording the set of pixels as the viable agriculture space, estimating a load capacity associated with the set of pixels.

Aspects of the above method include the method further comprising, prior to recording the set of pixels as the viable agriculture space, identifying a parapet associated with the set of pixels.

Aspects of the above method include wherein recording the set of pixels comprises updating an index.

Aspects of the above method include the method further comprising, prior to processing the image data, receiving a dataset associated with a city.

Embodiments include a user device comprising: a processor; and a computer-readable storage medium storing computer-readable instructions which, when executed by the processor, cause the processor to execute a method, the method comprising: receiving image data; processing the image data with an artificial intelligence model; determining, based on the processing of the image data, a set of pixels of the image data meets one or more thresholds associated with agricultural viability; and based on determining the set of pixels meets the one or more thresholds, recording the set of pixels as a viable agriculture space.

Aspects of the above user device include wherein the one or more thresholds comprise one or more of a size threshold and an angle threshold.

Aspects of the above user device include the method further comprising identifying the set of pixels as a rooftop.

Aspects of the above user device include wherein the agriculture space is a rooftop.

Aspects of the above user device include wherein the image data is geospatial data received from a satellite.

Aspects of the above user device include the method further comprising, prior to recording the set of pixels as the viable agriculture space, estimating a load capacity associated with the set of pixels.

Aspects of the above user device include the method further comprising, prior to recording the set of pixels as the viable agriculture space, identifying a parapet associated with the set of pixels.

Aspects of the above user device include wherein recording the set of pixels comprises updating an index.

Embodiments include a computer program product comprising: a non-transitory computer-readable storage medium having computer-readable program code embodied therewith, the computer-readable program code configured, when executed by a processor, to execute a method, the method comprising: receiving image data; processing the image data with an artificial intelligence model; determining, based on the processing of the image data, a set of pixels of the image data meets one or more thresholds associated with agricultural viability; and based on determining the set of pixels meets the one or more thresholds, recording the set of pixels as a viable agriculture space.

Aspects of the above computer program product include wherein the one or more thresholds comprise one or more of a size threshold and an angle threshold.

Aspects of the above computer program product include the method further comprising identifying the set of pixels as a rooftop.

Aspects of the above computer program product include wherein the agriculture space is a rooftop.

Aspects of the above computer program product include wherein the image data is geospatial data received from a satellite.

Aspects of the above computer program product include the method further comprising, prior to recording the set of pixels as the viable agriculture space, estimating a load capacity associated with the set of pixels.

Aspects of the above computer program product include the method further comprising, prior to recording the set of pixels as the viable agriculture space, identifying a parapet associated with the set of pixels.

Aspects of the above computer program product include wherein recording the set of pixels comprises updating an index.

Embodiments include a method of monitoring agriculture space, the method comprising: receiving data from one or more sensors, wherein each of the one or more sensors is associated with an agriculture space; generating one or more metrics indicative of farming viability associated with the agriculture space based on the data received form the one or more sensors; and generating a user interface comprising the generated metrics.

Aspects of the above method include wherein the one or more metrics comprise one or more of a temperature, a precipitation level, wind event data, air pressure change data, fertilization indicator, and a UHI temperature index.

Aspects of the above method include the method further comprising generating one or more recommendations based on the data received from the one or more sensors, wherein the one or more recommendations comprise one or more of a water recommendation, fertilizer recommendation, crop recommendation, planting recommendation, harvesting recommendation, and soil augmentation recommendation. Aspects of the above method include wherein the data comprises data processed by a processor of a device comprising the sensor.

Aspects of the above method include the method further comprising processing the data received from the one or more sensors.

Aspects of the above method include the method further comprising determining a location of the one or more sensors.

Aspects of the above method include wherein the one or more sensors comprise one or more of a soil sensor and a weather sensor.

Aspects of the above method include wherein the data is received from the one or more sensors via a field gateway.

Aspects of the above method include wherein the user interface comprises a summary of data associated with the sensors.

Aspects of the above method include the method further comprising generating one or more recommendations based on the data received from the one or more sensors, wherein the user interface further comprises the recommendations.

Embodiments include a user device comprising: a processor; and a computer-readable storage medium storing computer-readable instructions which, when executed by the processor, cause the processor to execute a method, the method comprising: receiving data from one or more sensors, wherein each of the one or more sensors is associated with an agriculture space; generating one or more metrics indicative of farming viability associated with the agriculture space based on the data received form the one or more sensors; and generating a user interface comprising the generated metrics.

Aspects of the above user device include wherein the one or more metrics comprise one or more of a temperature, a precipitation level, wind event data, air pressure change data, fertilization indicator, and a UHI temperature index.

Aspects of the above user device include the method further comprising generating one or more recommendations based on the data received from the one or more sensors, wherein the one or more recommendations comprise one or more of a water recommendation, fertilizer recommendation, crop recommendation, planting recommendation, harvesting recommendation, and soil augmentation recommendation.

Aspects of the above user device include wherein the data comprises data processed by a processor of a device comprising the sensor.

Aspects of the above user device include the method further comprising processing the data received from the one or more sensors.

Aspects of the above user device include the method further comprising determining a location of the one or more sensors.

Aspects of the above user device include wherein the one or more sensors comprise one or more of a soil sensor and a weather sensor.

Aspects of the above user device include wherein the data is received from the one or more sensors via a field gateway.

Aspects of the above user device include wherein the user interface comprises a summary of data associated with the sensors.

Aspects of the above method include the method further comprising generating one or more recommendations based on the data received from the one or more sensors, wherein the user interface further comprises the recommendations.

Embodiments include a computer program product comprising: a non-transitory computer-readable storage medium having computer-readable program code embodied therewith, the computer-readable program code configured, when executed by a processor, to execute a method, the method comprising: receiving data from one or more sensors, wherein each of the one or more sensors is associated with an agriculture space; generating one or more metrics indicative of farming viability associated with the agriculture space based on the data received form the one or more sensors; and generating a user interface comprising the generated metrics.

Aspects of the above computer program product include wherein the one or more metrics comprise one or more of a temperature, a precipitation level, wind event data, air pressure change data, fertilization indicator, and a UHI temperature index.

Aspects of the above computer program product include the method further comprising generating one or more recommendations based on the data received from the one or more sensors, wherein the one or more recommendations comprise one or more of a water recommendation, fertilizer recommendation, crop recommendation, planting recommendation, harvesting recommendation, and soil augmentation recommendation.

Aspects of the above computer program product include wherein the data comprises data processed by a processor of a device comprising the sensor.

Aspects of the above computer program product include the method further comprising processing the data received from the one or more sensors.

Aspects of the above computer program product include the method further comprising determining a location of the one or more sensors.

Aspects of the above computer program product include wherein the one or more sensors comprise one or more of a soil sensor and a weather sensor.

Aspects of the above computer program product include wherein the data is received from the one or more sensors via a field gateway.

Aspects of the above computer program product include wherein the user interface comprises a summary of data associated with the sensors.

Aspects of the above computer program product include the method further comprising generating one or more recommendations based on the data received from the one or more sensors, wherein the user interface further comprises the recommendations.

Aspects thus also include: a system on a chip (SoC) including any one or more of the above aspects disclosed herein; one or more means for performing any one or more of the above aspects disclosed herein; and/or any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices or collocated on a particular node/element(s) of a distributed network, such as a data processing or image processing network. As will be appreciated from the following description, and for reasons of computational efficiency, the components of the system can be arranged at any location within a distributed network without affecting the operation of the system.

While the above-described flowcharts have been discussed in relation to a particular sequence of events, it should be appreciated that changes to this sequence can occur without materially affecting the operation of the embodiment(s). Additionally, the exact sequence of events need not occur as set forth in the exemplary embodiments. Additionally, the exemplary techniques illustrated herein are not limited to the specifically illustrated embodiments but can also be utilized with the other exemplary embodiments and each described feature is individually and separately claimable.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, an image processing or big data processing device, any comparable means, or the like. In general, any device capable of implementing a state machine that is in turn capable of implementing the methodology illustrated herein can benefit from the various communication methods, protocols, and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJS™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as a program embedded on a personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a server.

It is therefore apparent that there has at least been provided systems and methods for improved agricultural optimization and data processing. While the embodiments have been described in conjunction with a number of embodiments, it is evident that many alternatives, modifications, and variations would be or are apparent to those of ordinary skill in the applicable arts. Accordingly, this disclosure is intended to embrace all such alternatives, modifications, equivalents, and variations that are within the spirit and scope of this disclosure.

1. A method of determining agriculture space viability, the method comprising:
receiving image data;
processing the image data with an artificial intelligence model;
determining, based on the processing of the image data, a set of pixels of the image data meets one or more thresholds associated with agricultural viability; and
based on determining the set of pixels meets the one or more thresholds, recording the set of pixels as a viable agriculture space.

2. The method of claim 1, wherein the one or more thresholds comprise one or more of a size threshold and an angle threshold.

3. The method of claim 1, further comprising identifying the set of pixels as a rooftop.

4. The method of claim 1, wherein the agriculture space is a rooftop.

5. The method of claim 1, wherein the image data is geospatial data received from a satellite.

6. The method of claim 1, further comprising, prior to recording the set of pixels as the viable agriculture space, estimating a load capacity associated with the set of pixels.

7. The method of claim 1, further comprising, prior to recording the set of pixels as the viable agriculture space, identifying a parapet associated with the set of pixels.

8. The method of claim 1, wherein recording the set of pixels comprises updating an index.

9. The method of claim 1, further comprising, prior to processing the image data, receiving a dataset associated with a city.

10. A user device comprising:
a processor; and
a computer-readable storage medium storing computer-readable instructions which, when executed by the processor, cause the processor to execute a method, the method comprising:
receiving image data;
processing the image data with an artificial intelligence model;
determining, based on the processing of the image data, a set of pixels of the image data meets one or more thresholds; and
based on determining the set of pixels meets the one or more thresholds, recording the set of pixels as a viable agriculture space.

11. The user device of claim 10, wherein the one or more thresholds comprise one or more of a size threshold and an angle threshold.

12. The user device of claim 10, wherein the method further comprises identifying the set of pixels as a rooftop.

13. The user device of claim 10, wherein the agriculture space is a rooftop.

14. The user device of claim 10, wherein the image data is geospatial data received from a satellite.

15. The user device of claim 10, wherein the method further comprises, prior to recording the set of pixels as the viable agriculture space, estimating a load capacity associated with the set of pixels.

16. The user device of claim 10, wherein the method further comprises, prior to recording the set of pixels as the viable agriculture space, identifying a parapet associated with the set of pixels.

17. The user device of claim 10, wherein recording the set of pixels comprises updating an index.

18. The user device of claim 10, wherein the method further comprises, prior to processing the image data, receiving a dataset associated with a city.

19. A computer program product comprising:
a non-transitory computer-readable storage medium having computer-readable program code embodied therewith, the computer-readable program code configured, when executed by a processor, to execute a method, the method comprising:
receiving image data;
processing the image data with an artificial intelligence model;
determining, based on the processing of the image data, a set of pixels of the image data meets a size threshold and an angle threshold; and
based on determining the set of pixels meets the size threshold and angle threshold, recording the set of pixels as a viable agriculture space.

20. The computer program product of claim 19, wherein the one or more thresholds comprise one or more of a size threshold and an angle threshold.

21. A method of monitoring agriculture space, the method comprising:
receiving data from one or more sensors, wherein each of the one or more sensors is associated with an agriculture space;
generating one or more metrics indicative of farming viability associated with the agriculture space based on the data received form the one or more sensors; and
generating a user interface comprising the generated metrics.

22. The method of claim 21, wherein the one or more metrics comprise one or more of a temperature, a precipitation level, wind event data, air pressure change data, fertilization indicator, and a UHI temperature index.

23. The method of claim 21, further comprising generating one or more recommendations based on the data received from the one or more sensors, wherein the one or more recommendations comprise one or more of a water recommendation, fertilizer recommendation, crop recommendation, planting recommendation, harvesting recommendation, and soil augmentation recommendation.

24. The method of claim 21, wherein the data comprises data processed by a processor of a device comprising the sensor.

25. The method of claim 21, further comprising processing the data received from the one or more sensors.

26. The method of claim 21, further comprising determining a location of the one or more sensors.

27. The method of claim 21, wherein the one or more sensors comprise one or more of a soil sensor and a weather sensor.

28. The method of claim 21, wherein the data is received from the one or more sensors via a field gateway.

29. The method of claim 21, wherein the user interface comprises a summary of data associated with the sensors.

30. The method of claim 21, further comprising generating one or more recommendations based on the data received from the one or more sensors, wherein the user interface further comprises the recommendations.

31.-40. (canceled)
